(19) United States
(12) Patent Application Publication
(10) Pub. No.: US 2006/0174274 A1
(43) Pub. Date: Aug. 3, 2006

(54) Methods of receiving movie previews and wireless communication devices configured for the same

(76) Inventors: Scott L. Vance, Cary, NC (US); David W. Bent JR., Cary, NC (US)

Correspondence Address: MYERS BIGEL SIBLEY & SAJOVEC, P.A., P.O. BOX 37428, RALEIGH, NC, 27627, US

(21) Appl. No.: 11/018,519

(22) Filed: Dec. 21, 2004

Related U.S. Application Data
(60) Provisional application No. 60/629,678, filed on Nov. 19, 2004.

(51) Int. Cl. H04N 5/445; G06F 13/00; G06F 3/00

(52) U.S. Cl. 725/45; 725/46; 725/44

(57) ABSTRACT

Methods of providing movie information are provided. Movie previews are broadcast in an order customized according to priority information associated with a movie provider. Related wireless communication devices are also discussed.

### CLAIM OF PRIORITY

This application claims priority to Provisional Application No. 60/629,678 (Attorney Docket No. 9314-99PR), filed on Nov. 19, 2004, the contents of which are incorporated herein by reference as if set forth in their entirety.

### FIELD OF THE INVENTION

The present invention relates to wireless communication devices and, more particularly, to wireless communication devices configured to receive broadcast messages and methods of operating the same.

### BACKGROUND OF THE INVENTION

Recently, there has been a proliferation in the field of wireless communications. Wireless communication devices such as cordless and cellular telephones, pagers, wireless modems, wireless email devices, personal digital assistants (PDAs) with communication functions, and other wireless communication devices are becoming commonplace. Some of these wireless communication devices are configured for Internet communications. Thus, users of these Internet capable wireless communication devices may use these devices to purchase products, gather information on products before the purchase thereof, obtain driving directions and the like.

In particular, websites such as Fandango.com and MovieTickets.com™ allow users to view movie trailers, movie reviews, and movie schedules. Users are also able to purchase tickets online at these websites, where the purchased tickets can be picked up at the box office prior to the movie by using a form of identification, such as the credit card that was used to purchase the tickets, or a transaction confirmation number. To obtain the movie information, a user typically logs on to the website or calls a toll free number, and requests information with respect to a particular movie.

### SUMMARY OF THE INVENTION

Some embodiments of the present invention provide methods of providing movie information. Movie previews are broadcast in an order customized according to priority information associated with a movie provider.

In further embodiments of the present invention, the movie previews may be broadcast using a short range transmitter such that wireless communication devices within about 10 to about 100 meters can receive the broadcast movie previews. In certain embodiments of the present invention, the movie previews may be broadcast independent of receiving a request for a particular movie preview.

In still further embodiments of the present invention, the priority information may include successful movies, unsuccessful movies, movies beginning within an hour of the present time and/or paid priority movies. The movie previews may include textual information about movies, video information about movies and/or audio information about movies. In certain embodiments of the present invention, the movie previews may include movie trailers. A request may be received to purchase at least one ticket to a movie selected based on the broadcast movie previews over a wireless link.

Some embodiments of the present invention may provide methods of receiving movie information. Broadcast movie previews may be received in an order customized according to priority information associated with a movie provider.

In further embodiments of the present invention, the broadcast movie previews may be received at a wireless communication device that is within about 10 to about 100 meters of a device broadcasting the movie previews. In certain embodiments of the present invention, the broadcast movie previews may be received independent of requesting a particular movie preview.

In still further embodiments of the present invention, a movie to view may be selected based on the broadcast movie previews. At least one ticket to the selected movie may be purchased and an authentication code may be received so as to allow a user to obtain the at least one purchased ticket.

Some embodiments of the present invention provide methods of providing movie information over a wireless link. An order for a plurality of movie previews based on priority information associated with a movie provider is determined. A wireless link is established between a movie information provision device of the movie provider and at least one wireless communication device. The plurality of movie previews are transmitted over the established wireless link in the determined order from the movie information provision device.

In further embodiments of the present invention, the transmitted plurality of movie previews may be received at the at least one wireless communication device in the determined order over the established wireless link. A movie to view may be selected based on the received plurality of movie previews and a ticket to the selected movie may be purchased over the established wireless link.

In still further embodiments of the present invention, the movie information provision device may be provided at a location associated with the movie provider, for example, at a movie theater associated with the movie provider. In certain embodiments of the present invention, the wireless link may be established between the movie information provision device of the movie provider and the at least one wireless communication device using a short range ad hoc network.

While the present invention is described above primarily with reference to methods, related devices are also provided.

### BRIEF DESCRIPTION OF THE DRAWINGS

FIG. 1 is a schematic diagram of mobile terminals according to some embodiments of the present invention and an exemplary base station transceiver.

FIG. 2 is a block diagram illustrating movie information provision devices and wireless communication devices according to some embodiments of the present invention.

FIG. 3 is a flowchart illustrating operations of movie information provision devices according to some embodiments of the present invention

FIG. 4 is a flowchart illustrating operations of wireless communication devices according to further embodiments of the present invention.

FIG. 5 is a flowchart illustrating operations of wireless communication devices according to further embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items. Dotted lines denote optional aspects of embodiments of the present invention. As will be appreciated by one of skill in the art, the present invention may take the form of an entirely hardware embodiment, an entirely software embodiment or an embodiment combining software and hardware aspects all generally referred to herein as a “circuit” or “module.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

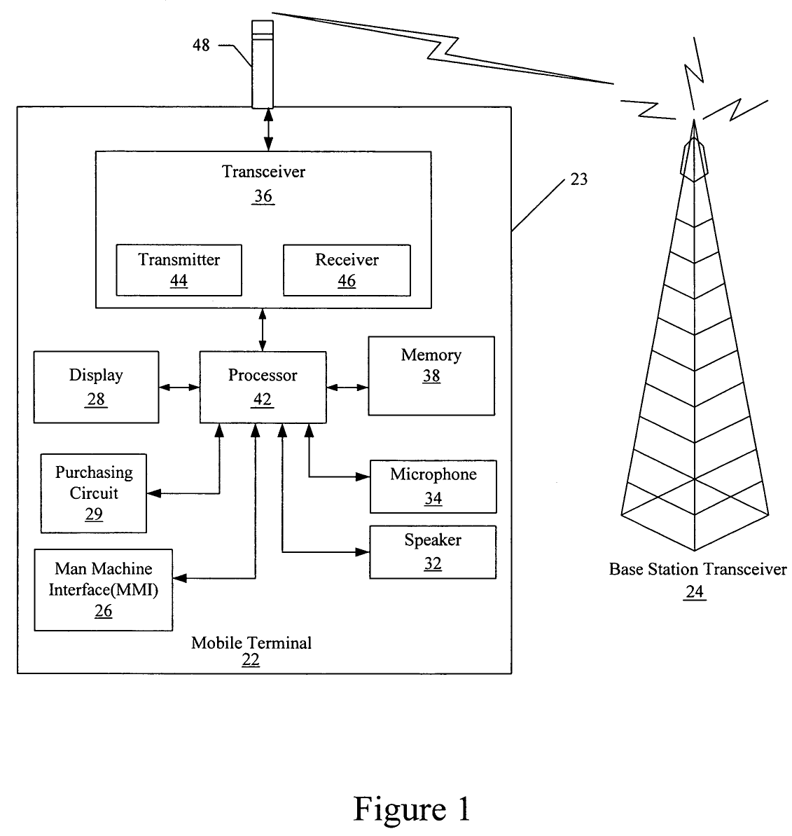

Embodiments of the present invention will now be described below with respect to FIGS. 1 through 5. Some embodiments of the present invention provide devices configured to broadcast movie previews in an order based on a priority associated with a movie provider, for example, a movie theater. Thus, the movie provider can decide which movie previews to present first to increase the likelihood that tickets to movies associated with the first movie previews broadcast will be purchased. For example, movie previews associated with movies that have not been very successful may be broadcast first, movie previews associated with movies that have been very successful may be broadcast first or movie previews that are associated with movies that the movie provider has been paid to promote may be broadcast first. In some embodiments of the present invention, the devices configured to broadcast the movie previews may include a short range transceiver/transmitter, for example, a Bluetooth transceiver or WiFi. In these embodiments of the present invention, wireless communication devices within about 10 to about 100 meters of the devices configured to broadcast movie previews may receive the broadcast movie previews. Accordingly, embodiments of the present invention may provide improved methods and devices for broadcasting and receiving movie previews as discussed herein below.

The present invention is described below with reference to schematic and block diagrams of mobile terminals configured to receive broadcast messages according to some embodiments of the present invention. Although embodiments of the present invention are discussed herein with respect to a mobile terminal, for example, mobile terminals 22 of FIG. 1, embodiments of the present invention are not limited to this configuration. Embodiments of the present invention may be included in any wireless communication device configured to receive broadcast messages without departing from the scope of the present invention.

As used herein, the term “wireless communication device” or “mobile terminal” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver.

Referring now to FIG. 1, illustrating an exemplary wireless communication system in accordance with some embodiments of the present invention, which includes the mobile terminal 22 and a base station transceiver 24 of a wireless communications network. The mobile terminal 22 includes a portable housing 23 and may include a man machine interface (MMI) 26, a display 28, a speaker 32, a microphone 34, a transceiver 36, and a memory 38, any of which may communicate with a processor 42. Furthermore, mobile terminals 22 according to embodiments of the present invention may further include a purchasing circuit 29 according to embodiments of the present invention, which also communicate with the processor 42. The processor 42 can be any commercially available or custom microprocessor.

The transceiver 36 typically includes a transmitter circuit 44 and a receiver circuit 46, which respectively transmit outgoing radio frequency signals to the base station transceiver 24 and receive incoming radio frequency signals, such as voice and data signals, from the base station transceiver 24 via an antenna 48. The antenna 48 may be an embedded antenna, a retractable antenna or any antenna known to those having skill in the art without departing from the scope of the present invention. The radio frequency signals transmitted between the mobile terminal 22 and the base station transceiver 24 may include both traffic and control signals (e.g., paging signals/messages for incoming calls), which are used to establish and maintain communication with another party or destination. The processor 42 may support various functions of the mobile terminal 22, including a receiver circuit 46 configured to receive broadcast messages and a purchasing circuit 29 configured to purchase movie tickets over a wireless link based on the broadcast movie previews.

It will be understood that in some embodiments of the present invention, the transceiver 36 may be a short range transceiver. The short range transceiver may be, for example, a Bluetooth transceiver, which may allow for high transfer rates of data over relatively short distances. It will be further understood that mobile terminals 22 according to some embodiments of the present invention may include a wireless transceiver and a short range transceiver/transmitter. The short range transceiver may communicate with devices within a particular range, for example, from about 10 to about 100 meters, without incurring charges associated with a wireless network. The wireless transceiver may be used to communicate with devices out of range using a wireless network.

In some embodiments of the present invention, the base station transceiver 24 comprises the radio transceiver(s) that defines an individual cell in a cellular network and communicates with the mobile terminal 22 and other mobile terminals in the cell using a radio-link protocol. Although only a single base station transceiver 24 is shown, it will be understood that many base station transceivers may be connected through, for example, a mobile switching center and other devices to define a wireless communications network.

Although the present invention may be embodied in communication devices or systems, such as the mobile terminal 22, the present invention is not limited to such devices and/or systems. Instead, the present invention may be embodied in any apparatus that may be configured to receive broadcast messages. Exemplary operations of the mobile terminal 22 will now be discussed with respect to FIG. 1. A user of a mobile terminal 22 may decide he wants to see a movie, but does not know which movie he would like to see. Thus, the user uses his mobile terminal 22 to access movie previews broadcast by a movie provider, for example, a movie theater. As used herein, “broadcast” or “broadcasting” refers to providing information such that a user of the mobile terminal 22 receives the information independent of a request for the information. It will be understood that broadcast (broadcasting) as used herein may include unicast, multicast, addressing and the like without departing from the scope of the present invention.

The user may access the movie previews by, for example, using the mobile terminal 22 to access a web site maintained by the movie provider or, if the user is within range, such as from about 10 to about 100 meters of the movie provider, using the mobile terminal to receive the broadcast movie previews using the short range transceiver. It will be understood that the user of the mobile terminal 22 does not have to request a movie preview associated with a particular movie, the movie previews are automatically presented in a predefined order as discussed further below. It will be understood that in embodiments of the present invention using a short range transceiver, the movie previews may automatically be broadcast to the mobile terminal 22 when the mobile terminal 22 comes within range.

As discussed herein, the movie provider may broadcast the movie previews in an order customized according to priority information associated with the movie provider. The movie previews may include textual information about movies, such as movie summaries, video information about movies, audio information about movies or any combination of the two. For example, “movie trailers”, as used herein, may refer to the combination of both video and audio information. The priority information may be based on movies that have been successful, movies that have been unsuccessful, movies beginning within a certain period of time of the present time, such as an hour, or movies that the movie provider has been paid to promote. For example, if the priority information is based on the unsuccessful movies, the movie previews associated with the unsuccessful movies may be broadcast first. Furthermore, the movie previews associated with the unsuccessful movies may be longer that the previews for the more popular movie or given more “appeal” than the previews for the more popular movies. Thus, the likelihood that an undecided movie goer will choose an unsuccessful movie may be increased.

In some embodiments of the present invention, the purchasing circuit 29 may be configured to purchase tickets to a movie selected based on the broadcast movie previews over a wireless link. In these embodiments of the present invention, the wireless communication device may be configured to receive an authentication code over the wireless link to allow the user to obtain the purchased tickets upon arrival at the movie theater. For example, in some embodiments of the present invention, a kiosk may be provided at the movie provider's location. Upon arrival at the kiosk, the user may be instructed to insert a credit card that was used to make the financial transaction for purchasing the tickets or to enter the confirmation authentication code. Once the code or card is authorized, the tickets may be printed at the kiosk. In some embodiments of the present invention, specifics with respect to the mobile terminal 22 may also be used to authenticate the purchase at the kiosk. For example, the SIM card or the RF ID, may be recognized at the kiosk.

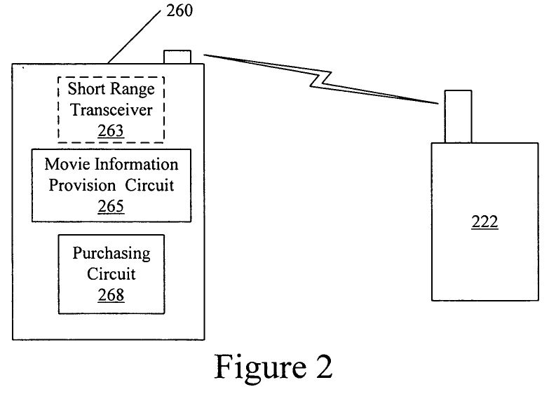

Referring now to FIG. 2, movie information provision devices and wireless communication devices according to some embodiments of the present invention will be discussed. As illustrated in FIG. 2, a wireless communication device 222, which may include the circuits and modules discussed with respect to the mobile terminal 22 of FIG. 1, may communicate with a movie information provision device 260. The movie information provision device 260 may be a physical device located at the location of the movie provider, for example, a movie theater, or may be a remote device associated with the movie provider. As illustrated in FIG. 2, the movie information provision device 260 includes an optional short range transceiver 263, a movie information provision circuit 265 and a purchasing circuit 268.

The movie information provision circuit 265 may be configured to broadcast movie previews in an order customized according to priority information associated with a movie provider. The movie information provision circuit 265 may broadcast the movie previews using for example, WiFi, short range broadcasting, such as Bluetooth, or the cellular network. In embodiments of the present invention including the short range transceiver 263, the short range transceiver 263 may be configured to broadcast movie previews such that devices, such as wireless communication devices 222, within about 10 to about 100 meters can receive the broadcast movie previews. Furthermore, in these embodiments of the present invention, the wireless communication device 222 does not have to request a particular movie preview. The wireless communication device 222 may automatically receive the broadcast movie previews when the wireless communication device comes within range of the movie information provision device 260.

As discussed above, the priority information may include successful movies, unsuccessful movies, movies beginning within an hour of the present time or paid priority movies. Furthermore, the movie previews may include textual information about movies, video information about movies, audio information about movies or any combination of these. For example, movie trailers may be a combination of video and audio information about movies.

As further illustrated in FIG. 2, the movie information provision device 260 further includes a purchasing circuit 268 configured to provide a method of purchasing a movie selected based on the broadcast movie previews over a wireless link between the movie information provision device 260 and at least one wireless communication device 222. Thus, once a movie goer hears the broadcast movie trailers, he may select a movie and purchase tickets from the remote location. At this point, the movie goer may be assigned an authorization code, which may be used to obtain tickets once the movie goer arrives at the movie provider's location, for example, at the movie theater. It will be understood that many methods of obtaining entrance to the theater once the tickets are purchased may be used without departing from the scope of the present invention.

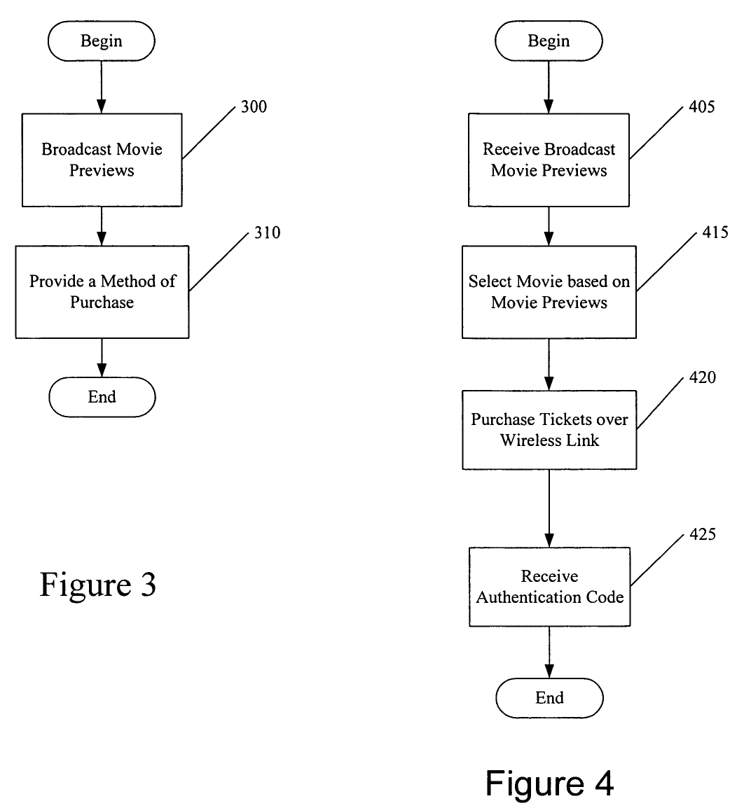

Referring now to FIGS. 3 and 4, operations of devices according to embodiments of the present will be discussed. Referring now to FIG. 3, operations begin at block 300 by broadcasting movie previews in an order customized according to priority information associated with a movie provider. The broadcasting may be via a short range transceiver, WiFi and/or a cellular transceiver. In embodiments of the present invention using a short range transceiver, devices within about 10 to about 100 meters can receive the broadcast movie previews. In these embodiments of the present invention, the movie previews may be broadcast to devices within range independent of receiving a request for a particular movie preview. In some embodiments of the present invention, a method of purchasing a movie selected based on the broadcast movie previews over a wireless link may be provided (block 310).

Referring now to FIG. 4, operations of wireless communication devices according to embodiments of the present invention will be discussed. Operations begin at block 405 by receiving broadcast movie previews in an order customized according to priority information associated with a movie provider. The wireless communication device may receive broadcast movie previews using a short range transceiver, a cellular network and the like. In embodiments of the present invention including a short range transceiver, the broadcast movie previews may be received at a wireless communication device that is within about 10 to about 100 meters of a device broadcasting the movie previews. In these embodiments of the present invention, the broadcast movie previews may be received independent of requesting a particular movie preview. A movie to view may be selected based on the broadcast movie previews (block 415). Tickets to the selected movie may be remotely purchased over a wireless link (block 420). Once purchased, an authentication code may be received so as to allow a user to obtain the purchased tickets (block 425).

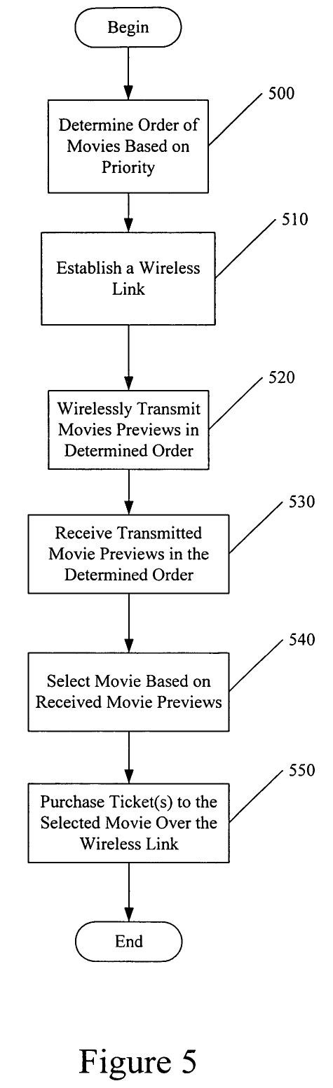

Referring now to FIG. 5, operations for providing movie information according to some embodiments of the present invention begin at block 500 by determining an order for a plurality of movie previews based on priority information associated with a movie provider. The priority information may include successful movies, unsuccessful movies, movies beginning within an hour of the present time, paid priority movies and the like. A wireless link may be established between a movie information provision device of the movie provider and at least one wireless communication device (block 510). The movie information provision device may be located at a location associated with the movie provider, for example, a movie theater. The priority information may be associated with the movies being shown or to be shown at the movie theater. The wireless link may be established, for example, using a short range transceiver and/or a wireless communication network. For example, the movie provider may have a contract with the wireless communication provider such that the wireless communication network may be configured to detect movie information transmitted from the movie information provision device and provide the movie information to the wireless communication device(s). The plurality of movie previews are transmitted over the established wireless link in the determined order from the movie information provision device to the wireless communication device(s) (block 520).

The transmitted plurality of movie previews may be received at the wireless communication device(s) in the determined order over the established wireless link (block 530). It will be understood that the wireless communication device does not have to request the movie information. A movie may be selected based on the plurality of movie previews (block 540) and at least one ticket to the selected movie may be purchased over the established wireless link (block 550).

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method of providing movie information comprising broadcasting movie previews in an order customized according to priority information associated with a movie provider.

2. The method of claim 1, wherein broadcasting further comprises broadcasting movie previews using a short range transmitter such that devices within about 10 to about 100 meters can receive the broadcast movie previews.

3. The method of claim 2, wherein broadcasting further comprises broadcasting the movie previews independent of receiving a request for a particular movie preview.

4. The method of claim 1, wherein the priority information comprises successful movies, unsuccessful movies, movies beginning within an hour of the present time and/or paid priority movies.

5. The method of claim 1, wherein the movie previews comprise textual information about movies, video information about movies and/or audio information about movies.

6. The method of claim 1, wherein the movie previews comprise movie trailers.

7. The method of claim 1, further comprising receiving a request to purchase at least one ticket to a movie selected based on the broadcast movie previews over a wireless link.

8. A method of receiving movie information comprising receiving broadcast movie previews in an order customized according to priority information associated with a movie provider.

9. The method of claim 8, wherein receiving further comprises receiving the broadcast movie previews at a wireless communication device that is within about 10 to about 100 meters of a device broadcasting the movie previews.

10. The method of claim 8 wherein receiving further comprises receiving the broadcast movie previews independent of requesting a particular movie preview.

11. The method of claim 8, wherein the priority information comprises successful movies, unsuccessful movies, movies beginning within an hour of the present time and/or paid priority movies.

12. The method of claim 8, wherein the movie previews comprise textual information about movies, video information about movies and/or audio information about movies.

13. The method of claim 8, wherein the movie previews comprise movie trailers.

14. The method of claim 8, further comprising:
selecting a movie to view based on the broadcast movie previews;
purchasing at least one ticket to the selected movie; and
receiving an authentication code so as to allow a user to obtain the at least one purchased ticket.

15. A device configured to provide movie information comprising a movie information provision circuit configured to broadcast movie previews in an order customized according to priority information associated with a movie provider.

16. The device of claim 15, wherein the movie information provision circuit comprises a short range transmitter configured to broadcast movie previews such that devices within about 10 to about 100 meters can receive the broadcast movie previews.

17. The device of claim 15 wherein the movie information provision circuit is further configured to broadcast the movie previews independent of receiving a request for a particular movie preview.

18. The device of claim 15, wherein the priority information comprises successful movies, unsuccessful movies, movies beginning within an hour of the present time and/or paid priority movies.

19. The device of claim 15, wherein the movie previews comprise textual information about movies, video information and/or audio information about movies.

20. The device of claim 15, wherein the movie previews comprise movie trailers.

21. The device of claim 15, further comprising a purchasing circuit configured to allow at least one ticket to a movie selected based on the broadcast movie previews to be purchased over a wireless link.

22. A wireless communication device configured to receive movie information comprising a receiver configured to receive broadcast movie previews in an order customized according to priority information associated with a movie provider.

23. The wireless communication device of claim 22, wherein the receiver is further configured to receive the broadcast movie previews at the wireless communication device that is within about 10 to about 100 meters of a device broadcasting the movie previews.

24. The wireless communication device of claim 22 wherein the receiver is further configured to receive the broadcast movie previews independent of requesting a particular movie preview.

25. The wireless communication device of claim 22, wherein the priority information comprises successful movies, unsuccessful movies, movies beginning within an hour of the present time and/or paid priority movies.

26. The wireless communication device of claim 22, wherein the movie previews comprise textual information about movies, video information about movies and/or audio information about movies.

27. The wireless communication device of claim 22, wherein the movie previews comprise movie trailers.

28. The wireless communication device of claim 22, further comprising:
a man machine interface configured to allow selection of a movie based on the broadcast movie previews over a wireless link; and
a purchasing circuit configured to purchase at least one ticket to the selected movie over the wireless link and receive an authentication code over the wireless link so as to allow a user to obtain the at least one purchased ticket.

29. A method of providing movie information over a wireless link, comprising:
determining an order for a plurality of movie previews based on priority information associated with a movie provider;
establishing the wireless link between a movie information provision device of the movie provider and at least one wireless communication device; and
transmitting the plurality of movie previews in the determined order over the established wireless link.

30. The method of claim 29, further comprising receiving over the established wireless link, at the at least one wireless communication device, the transmitted plurality of movie previews in the determined order.

31. The method of claim 30, further comprising:
selecting a movie to view based on the received plurality of movie previews; and
purchasing a ticket to the selected movie over the established wireless link.

32. The method of claim 29, wherein the movie information provision device is provided at a location associated with the movie provider.

33. The method of claim 32, wherein establishing further comprises establishing a wireless link between the movie information provision device of the movie provider and the at least one wireless communication device using a short range ad hoc network.

34. A device for providing movie information over a wireless link, comprising:
a movie information provision circuit configured to:
determine an order for a plurality of movie previews based on priority information associated with a movie provider;
establish the wireless link between the device and at least one wireless communication device; and
transmit the plurality of movie previews in the determined order over the established wireless link.

35. The device of claim 34, wherein the device is provided at a location associated with the movie provider.

36. The device of claim 35, wherein movie information provision circuit is further configured to establish the wireless link between the device of the movie provider and the at least one wireless communication device using a short range ad hoc network.

37. A wireless communication device comprising a receiver circuit configured to receive a plurality of movie previews in an order determined by a movie provider over an established wireless link.

38. The wireless communication device of claim 37, further comprising:
a man machine interface configured to allow selection of a movie to view based on the received plurality of movie previews; and
a purchasing circuit configured to purchase a ticket to the selected movie over the established wireless link.
